(19) United States
(12) Patent Application Publication
(10) Pub. No.: US 2012/0142232 A1
(43) Pub. Date: Jun. 7, 2012

(54) RESILIENT-LOADED CONNECTOR

(75) Inventors: Bihui Yin, Shanghai (CN); Shan Qin, Shanghai (CN); Claude Brocheton, Shanghai (CN)

(73) Assignee: RADIALL, Rosny sous Bois (FR)

(21) Appl. No.: 13/386,743

(22) PCT Filed: Aug. 3, 2010
(86) PCT No.: PCT/IB10/53520

§ 371 Date: Feb. 17, 2012

(30) Foreign Application Priority Data
Aug. 3, 2009 (CN) 200910055826.7

(51) Int. Cl. H01R 4/48

(52) U.S. Cl. 439/817

(57) ABSTRACT

A resilient-loaded connector, which includes a receptacle and an adapter. The receptacle has a body and a center contact received inside the body. The adapter has a plug that includes a body and a central contact mounted in the body with an insulator being interposed. The body of the receptacle has an internal surface including a first tapered surface, a second tapered surface and a cylindrical surface between the first and second tapered surfaces. The adapter also includes a resilient structure. The central contact of the plug of the adapter has at least one slot that is configured to cooperate with the central contact of the receptacle. The central contact of the receptacle is for instance received inside the central contact of the plug.

### FIELD

This invention concerns a RF coaxial connector

### BACKGROUND

The trend of base station design is to minimize the size and integrate the TX and RX module on the same printed circuit board (PCB). However, as the transmission power increases, so do the requirements for overcoming radial and/or axial misalignments, and RF leakage as well. For board to board applications (later referred as BTB applications), due to the tolerances of manufacture and assembly, there may be a need for horizontal and/or vertical tolerances for positioning while assembling coaxial connectors, which may directly affect the radial and axial alignment of the coaxial connectors.

With such axial and/or radial misalignment, the number of board to board connectors in one pair of PCBs should remain low, which may affect the board to board connection technology and modular development.

There are several existing technologies for Board to Board connection:
1. Connection of the RX module and the TX module by cable assembly. Thanks to the flexibility of the cable, this kind of connection has minimal requirements for the position tolerance for the PCB. However, this kind of connection has drawbacks concerning the modular and integrated design, and tends to increase the cost of assembly and the complexity for end users as well. This kind of connection may also present issues related to future maintenance and repair.
2. The use of standard coaxial connectors directly, such as SMB and MCX. In this kind of connection, misalignments are mainly overcome by the elastic deformation of the slotted outer contact and central contact of the connectors. To overcome significant misalignments, relatively important deformations of the contacts of the connectors are desirable, but these deformations are limited by the maximum allowable stress that may be borne by the material of which the contacts are made. For example, a central contact may be destroyed when overloaded compensating for deformation created by a significant misalignment. Therefore, these standard connectors may only be capable of overcoming very small misalignments. As a consequence, these connectors may not properly compensate for axial and/or radial misalignments.
3. The use of MMBX and SMP series. These kinds of designs use a receptacle-adapter-receptacle structure, which could provide relatively large misalignments. As these kinds of connectors use slotted design for the outer contacts and inner contacts, limitations for the misalignment compensation still exist. With MMBX series, radial misalignment is about to +/−0.4 mm while axial misalignment is about +/−0.3 mm. With SMP series, radial misalignment is about +/−0.25 while axial misalignment is about to 0/+0.25 mm.

Furthermore, because of the slots provided in the outer contact of the connectors, relatively large RF leakage may occur, which tends to generate electromagnetic interference. This downgrades the properties of such connectors.

There therefore remains a need for providing a coaxial connector overcoming the above-mentioned misalignment and/or RF leakage drawbacks.

### SUMMARY

Exemplary embodiments of the invention provide an effective coaxial connector despite large radial and/or axial misalignments, particularly capable of overcoming large radial and/or axial misalignments, and/or also having good shielding, and/or relative high power handling, and/or good electrical RF performance.

Exemplary embodiments of the invention thus provide a resilient-loaded, e.g. spring-loaded, connector comprising:
a receptacle comprising a body and a central contact inside the body and,
at least one adapter having a plug, the plug comprising a body and a central contact mounted in said body with an insulator being interposed, therebetween.
   the adapter and the receptacle being configured to be connected together at one end of the adapter, the internal surface of the body of the receptacle including a tapered surface, also referred later as “second tapered surface”, the adapter having a resilient element , e.g. a spring, the body of the plug including a portion configured to be introduced into the body of the receptacle, said portion of the body of the plug having a non-slotted surface contacting said tapered surface of the internal surface of the receptacle when the adapter and the receptacle are jointed, in particular connected.

Other exemplary embodiments of the invention provide a spring-loaded connector which includes a receptacle and an adapter connected to the receptacle.

The receptacle may comprise a body and a central contact inside said body.

The adapter may have a plug. The plug may comprise a body and a central contact mounted in said body with an insulator being interposed therebetween.

The internal surface of the receptacle's body may include a second tapered surface; the adapter may have an element having a spring structure. The body of the adapter may comprise an insertion part having a non-slotted surface which may contact the second tapered surface of the internal surface of the body of the receptacle.

The central contact of the receptacle may have a front surface.

The central contact of the plug of the adapter may have at least one slot configured to receive the central contact of the receptacle, in particular the front surface of said central contact, when the adapter and the receptacle are connected together.

The internal surface of the receptacle may comprise at least another tapered surface, also later referred as “first tapered surface” and at least one cylindrical surface located between the first tapered surface and the second tapered surface.

The surface of the body of the adapter may be a continuous or a discontinuous surface.

The coaxial connector may further include a second receptacle configured to be connected to the adapter at another end of said adapter. The second receptacle may comprise a body, a central contact and a clip configured to lock the adapter onto the second receptacle.

Other exemplary embodiments of the invention also provide a resilient-loaded connector, comprising:
a receptacle comprising a body and a central contact inside the body, and
at least one adapter having a plug, the plug comprising a body and a central contact mounted in said body with an insulator being interposed, said adapter and receptacle being configured to be connected together at one end of said adapter,
   the internal surface of the body of the receptacle including a tapered surface, also later referred as “second tapered surface”, the adapter having a resilient element, e.g. a spring; the central contact of the adapter having a front surface, the body of the plug comprising a portion configured to be introduced into the body of the receptacle, said portion of the body of the plug having a non-slotted surface contacting said tapered surface of the body of the receptacle,
   the central contact of the receptacle comprising at least one slot configured to receive the front surface of the central contact of the adapter when the adapter and the receptacle are connected.

Other exemplary embodiments of the invention provide a connector, comprising a receptacle and at least one adapter.

The receptacle may comprise a body and a central contact inside the body.

The adapter may have a plug. The plug may comprise a body and a central contact mounted in said body with an insulator being interposed therebetween.

The internal surface of the body of the receptacle may include a second tapered surface, the adapter having an element having a spring structure. The central contact of the adapter may have a front surface. The insertion part of the body of the adapter may have a non-slotted surface configured to contact with the second tapered surface of the internal surface of the body of the receptacle.

The central contact of the receptacle may have at least one slot, e.g. a plurality of slots, configured to contact with the surface of the central contact of the plug of the adapter when the adapter and the receptacle are connected together.

Connectors according to the above-mentioned exemplary embodiments of the invention may provide the following assets. The tapered surface(s) of the receptacle may enable good contact to be established with the surface of the adapter when the adapter is tilted according to a certain angle.

Furthermore, the surface of the central contact of the receptacle may have good concentricity with the surface of the body of the plug of the adapter, which may assure that good contact is established when one of the adapter and the receptacle is tilted according to a certain angle. Such connectors may be effective despite radial misalignments having a value of up to or at least +/−2 mm.

The force generated by the resilient element of the adapter may enable exertion of force onto the receptacle when in a working range, which may provide low contact resistance and may thus increase the power handling of the connector. This may also enable the connector to work despite axial misalignments having values of up to or at least +/−1 mm.

The non-slotted structure of the portion of the body of the plug of the adapter configured to be introduced into the body of the receptacle may improve the RF shielding of the connection,

With such a connector, axial and/or radial misalignment may be overcome, which may lower the position tolerance requirements of the connector while manufacturing the PCBs. As a consequence, the costs of manufacture of the PCBs and of the connectors may be reduced.

The above-mentioned exemplary embodiments of the invention may also enable more pairs of coaxial connection to be made between two PCBs, without having to resort to too many cables or even to cables, enabling the modular, systematic and small-scale development of the base station. Low RF leakage may prevent signal interference, providing satisfactory results as regards the integration of TX and RX modules.

### DESCRIPTION OF THE DRAWINGS

FIG. 1 is a cross-sectional view of a receptacle according to exemplary embodiments of the invention,

FIG. 2 is a cross-sectional view of an adapter according to exemplary embodiments of the invention,

FIG. 3 is a cross-sectional view of the adapter of FIG. 2 when connected to the receptacle of FIG. 1 at one end and to a second receptacle at its other end,

FIGS. 4 and 5 show different configurations of the connection between an adapter and receptacles according to exemplary embodiments of the invention, each receptacle being connected at one end of the adapter,

FIG. 6 is a cross-sectional view of a second receptacle according to exemplary embodiments of the invention,

FIG. 7 shows a variant of the connector of FIG. 3

FIG. 8 shows a BTB application of exemplary embodiments of the invention,

FIG. 9 Illustrate the MTM application of exemplary embodiments of the invention,

FIGS. 10 and 11 emphasize radial misalignment that may occur between two receptacles that are to be connected to the same adapter and,

FIG. 12 shows a coaxial connector of the prior art.

### SPECIFIC IMPLEMENTATION

Some non-restrictive exemplary embodiments will now be described.

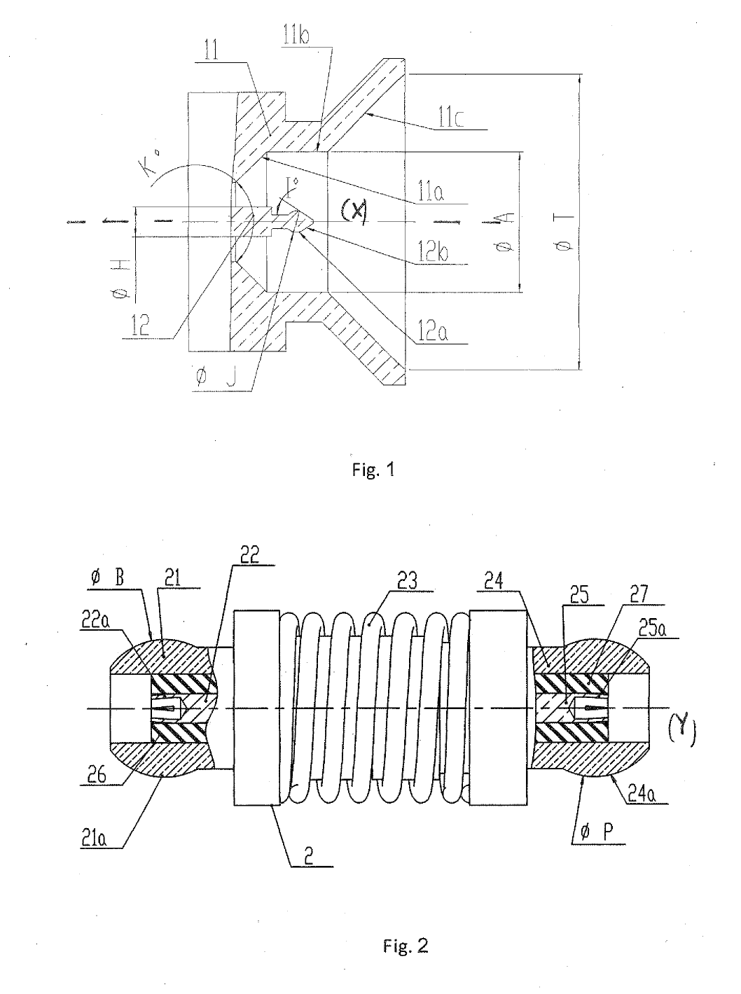

FIGS. 1 to 3 show exemplary embodiments of a RF coaxial connector according to the invention.

The RF coaxial connector of FIGS. 1 to 3 comprises a receptacle 1 and an adapter 2 configured to be connected to the receptacle at one of its ends 1.

The receptacle 1 as described includes a body 11 and a central contact 12 which is received inside a housing, said housing being for example located in the middle of the body 11. According to the embodiment of FIG. 1, the internal surface of the receptacle 1 comprises three different parts, these parts including a first tapered surface 11c which is a horn structure used for guiding, a second tapered surface 11a and a cylindrical surface 11b located between the first tapered surface 11c and the second tapered surface 11a. The cylindrical surface 11b may extend around a longitudinal axis (X). This axis (X) may define an axis of symmetry of the receptacle 1.

The diameter A of the cylindrical surface of the internal surface of the receptacle lies for example between 6 and 7 mm, such a diameter A being for example 0-1 mm larger than the largest diameter B of a portion of a body 21 of a plug of the adapter 2, said portion being configured to be introduced into the body 1 of the receptacle 1. The taper angle K of the second tapered surface of the internal surface of the receptacle body 11 may lie between 82 degrees and 101 degrees. As shown on FIG. 1, the taper angle K may be the angle between two portions of the second tapered surface 11a, said two portions each extending, in a plane containing the axis X, on a different side of this axis (X).

The largest diameter T of the first tapered surface 11c of the internal surface of the receptacle is for example between 13 and 15.5 mm. Such a diameter is measured in a plane containing the axis (X) between two portions of the first tapered surface 11e at the free end of said first tapered surface 11c, for example at the free end of the horn structure when the first tapered surface forms a horn.

Although FIG. 1 shows a receptacle with a first tapered surface forming a horn structure, the invention is not limited to such a receptacle. In some embodiments (not shown), the internal surface of the receptacle may be void of such a first tapered surface, being only formed by the second tapered surface 11a and the cylindrical surface 11b. The horn structure used for guiding may thus be removed.

As shown on FIG. 1, the central contact 12 of the receptacle 1 may include four parts: a back part, a middle part, a front part and a top part.

The back part may be cylindrical, having a diameter H that is for example approximately 1.11.5 mm. The middle part may also be cylindrical, having a diameter smaller than the diameter H of the back part. According to the embodiment described the two above-mentioned diameters are measured perpendicularly to the axis (X).

The front part may have a front surface 12a configured to cooperate with the slotted internal surface 22a of the central contact 22 of the adapter 2 that is described in greater detail below for connecting the adapter 2 and the receptacle.

The top part 12b may be tapered, having a largest diameter J lying for example between 0.7 and 1 mm. Contrary to the above-mentioned diameters, the diameter J corresponds to the greatest transversal dimension of the top part 12b of the central contact, such a dimension being measured transversally but not necessarily perpendicularly relative to the axis (X).

The top part 12b of the central contact 12 may form the end of the central contact that faces the adapter 2.

The adapter 2 includes a plug. The plug comprises a body 21 and a central contact 22 mounted in the body 21 with an insulator 26 being interposed therebetween. The body 21 extends along a longitudinal axis (Y).

As shown in FIG. 2, the adapter 2 further comprises an element 23 having a resilient structure, for example a spring 23 according the embodiment currently described. Said spring extends around the body 21 of the plug.

As may be seen in FIG. 2, the central contact 22 of the plug of the adapter 2 may have a slot 22a configured to receive the central contact 12, and in particular the front portion 12a and back portion 12b of said central contact 12.

The body 21 of the plug of the adapter 2 may further comprise a portion configured to be introduced into the body 11 of the receptacle, said portion of the body 21 of the plug having a non-slotted surface 21a contacting said second tapered surface 11a of the internal surface of the receptacle 1 when the adapter and the receptacle are connected.

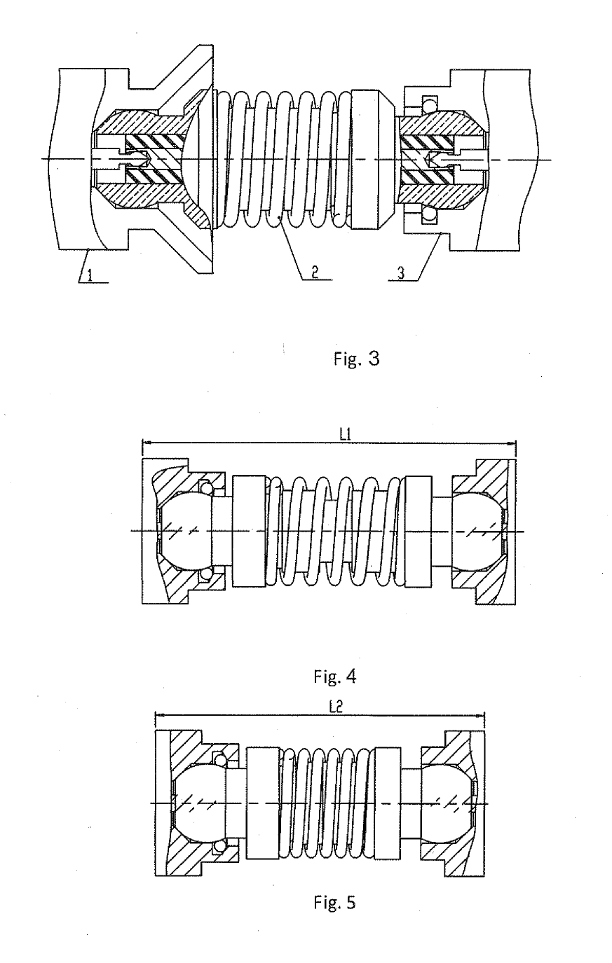

As shown in FIGS. 3 to 5, another end of the adapter 2 may be connected to a second receptacle 3 having a structure similar or different from the structure of the receptacle 1.

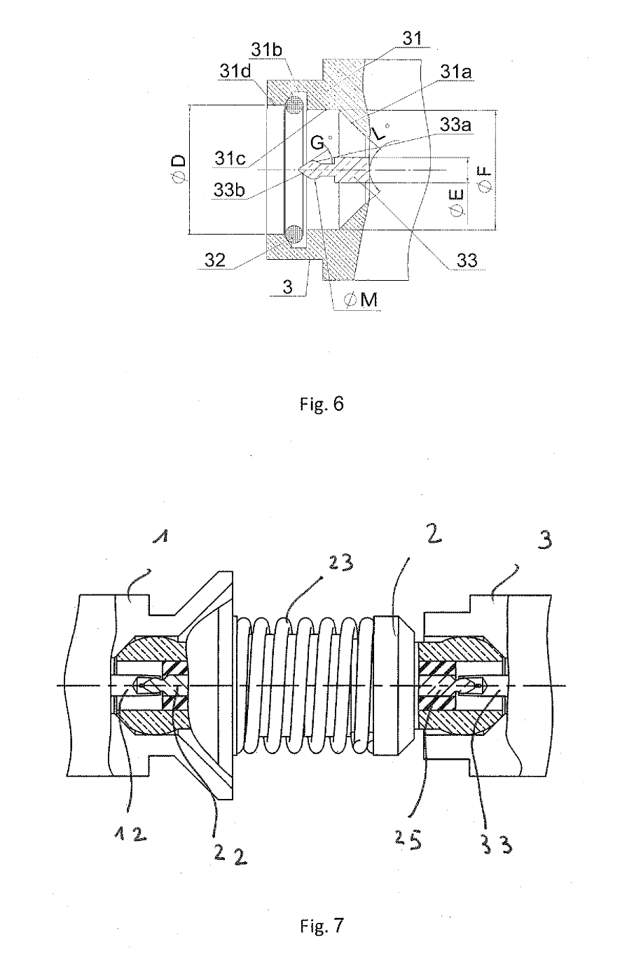

In the embodiment shown at FIG. 3, the adapter is connected at its other side to a receptacle 3 that is shown in FIG. 6 and that presents a structure different from the receptacle 1 of FIG. 1.

This second receptacle 3 includes a body 31, a central contact 33 and a clip 32. In other embodiments, the clip 32 may be replaced by a ring, e.g. a C ring.

The internal surface of the body 31 of the receptacle 31 comprises a single tapered portion 31a, similar to the second tapered portion of the receptacle 1 of FIG. 1. The internal surface of the body 31 shown in FIG. 6 also comprises a groove 31b close to the free end of the body that is to contact with the adapter 2. The clip 32 is received in this groove 31b. The clip 32 may be set in the groove 31b prior to or after connection of the adapter 2 and the second receptacle 3.

The other elements of the second receptacle 3, i.e. the other parts of the inner surface of the body 31 and the central contact 33 may be the same as those of the receptacle 1.

The other end of the adapter 2 that configured to be connected to the second receptacle 3 may have the same structure as the end configured to be connected to the receptacle 1 that has been previously described, including a plug comprising a body 24 and a central contact 25 mounted in said body with an insulator 27 being interposed therebetween. Similarly to what has been described so far, the body 24 of the plug may comprise a portion configured to be introduced into the body of the second receptacle 3, said portion of the body of the plug having a non-slotted surface 24a contacting the second tapered surface of the internal surface of the second receptacle 3 when the adapter 2 and the second receptacle 3 are connected. The central contact 25 may also comprise a slot 25a.

The adapter may thus be connected to receptacles 1 and 3 of same or different structures at both its both ends.

In the above-mentioned embodiments, the body 21 of the adapter 2 may be assembled with the spring 23.

The surface of the body 21 of the adapter 2 may define a continuous surface (e.g. a surface being constituted by a single arc) or a discontinuous surface (e.g. a surface being constituted by several arcs). However, in other exemplary embodiments of the invention, the spherical surface of the body 21 may be replaced by any other shape, provided the center position remains under working conditions.

When there is a misalignment between the receptacle 1 or 3 and the adapter 2, the contact between the body 21 or 24 of the adapter and the body of the receptacle 1 or 3 may form a continuous circle. The pressure between the adapter 2 and the receptacle 1 or 3 is, in the example presently described, generated by pre-load of the minimum deformation of the spring 23.

When this coaxial connector is in working range, the electrical contact between the central contacts of the receptacles 1 and 3 and the central contact of the adapter 2 may be located in the rotation center of the adapter body.

In all or some of the above-mentioned embodiments, when the adapter 2 is fully inserted into the tapered surface 11a of the receptacle 1, the center of the non-slotted surface 21a has a 1 mm diameter concentricity with the center of the surface of the central contact 12 of the receptacle 1. The other side of the adapter has a slotted central contact 25. The body 24 of the adapter 2 has a non-slotted surface 24a. The insulator 26 or 27 lies between the central contact 22 or 25 and the body 21 or 24.

The taper angle I on the front part of the central contact 12 of the receptacle 1 is, for example, lying between 18 degrees and 26 degrees. When any side of the adapter 2 is inserted into the receptacle 1 or 3 totally, the concentricity between the two centers of the surface is for example, 1 mm.

This invention is not limited to the above-mentioned exemplary embodiments. The central contact of the receptacle 1 or 3 need not have pins and the central contact 22 or 25 of the adapter need not have slots. The connector of FIG. 7 differs from the connector of FIG. 1 by the fact that the central contacts 12 and 33 comprise slots configured to receive pins carried by the central contacts 22 and 25 of the adapter 2.

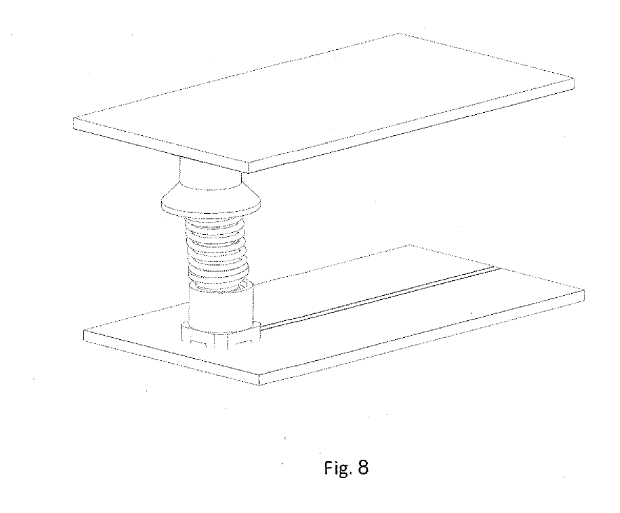

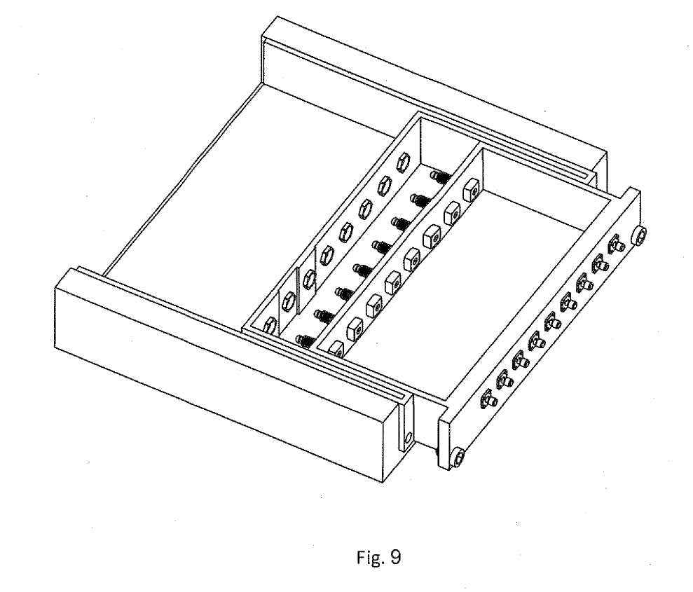

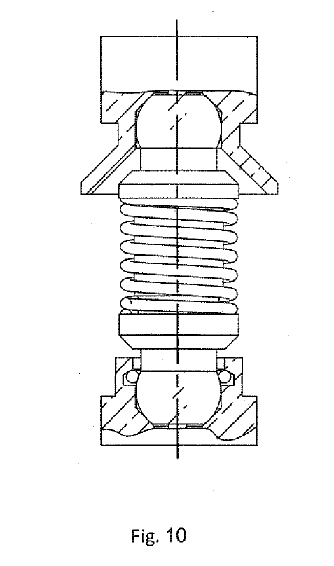

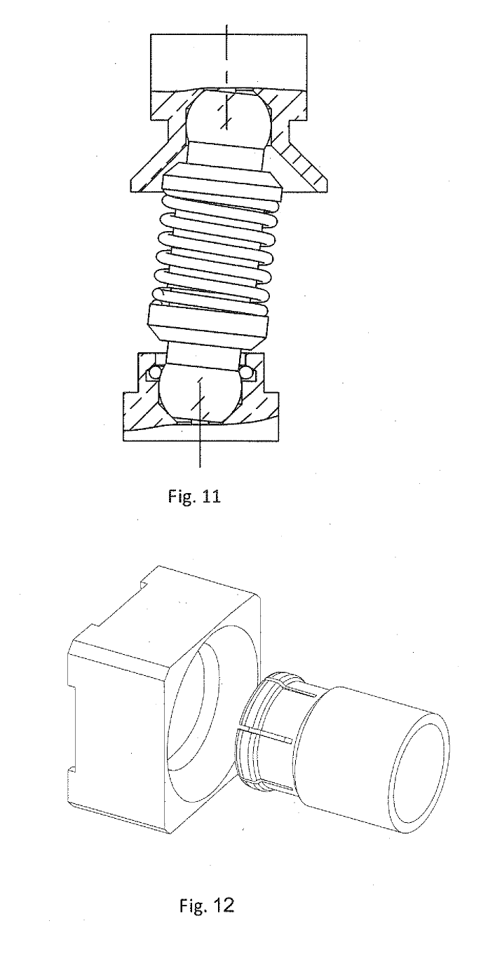

FIGS. 8 and 9 will now be described. As shown, the receptacle 3 to which one end of the adapter 2 is connected may be fastened to a PCB. As in the example of FIG. 1, the receptacle 1 of FIG. 8 has a body comprising a first tapered surface 11e, this tapered surface 11e forming a horn structure. Thanks to this horn structure, the end of the adapter 2 that is to be connected to the receptacle 1 may be guided into the receptacle 1 despite a radial misalignment between the adapter 2 and the receptacle 1, said radial misalignment lying in a certain range. When the BTB distance comes into working range, the spring structure part may become compressed.

The surface of the body of the adapter is received inside the receptacle 1 and contacts with the internal surface of the body of the receptacle 1. Thanks to the force generated by the spring or any similar element having a resilient structure, the surface of the body of the adapter will tangentially intersect with the second tapered surface of the body of the receptacle and generate cyclical contact, thus enabling the contact resistance to decrease accordingly.

Accordingly connectors consistent with embodiments of the invention may handle very high power. And because of the contact between the surface 21a of the body 21 of the adapter 2 and the tapered surface 11a of the receptacle 1, when the adapter 2 is tilted due to the tolerance by the manufacture of the PCB, the contact between the adapter 2 and the receptacle 1 may remain constant, thus enabling constant electrical performances of the connector when the adapter 2 is tilted.

Because of the guiding function of the first tapered surface 11a and because the first tapered surface H a is located closer to the adapter 2 than the front portion 12a of the central contact 12, the central contact (12) of the receptacle 1 may be introduced in a relatively easy manner into the central contact (22) of the adapter 2. When the adapter 2 is inserted into the receptacle 1, the central contact 12 of the receptacle 1 has been inserted correctly into the central contact 22 of the adapter 2.

Because of the concentricity between the surface of central contact 12 of the receptacle 1 and the surface 21a of the body of the adapter, such a concentricity corresponding for example to a diameter of 1 mm, when the adapter 2 is tilted according to a certain angle, the contact between the central contact 12 of the receptacle 1 and the central contact 22 of the adapter 2 may remain constant cyclically. In other words, the contact resistance may remain the same when the adapter 2 is tilted, while constant electrical performance is assured when the adapter is tilted. A coaxial connector according to exemplary embodiments of the invention may thus compensate for relatively large radial misalignment.

As may be seen on FIG. 12, coaxial connectors according to the prior art and subjected to radial misalignment have a slotted body or a slotted outer contact structure, leading to significant RF leakages generated in high frequency transmission.

According to exemplary embodiments of the invention, the body 21 or 24 of the adapter 2 does not have a slotted structure. When in working conditions, the body 21 or 24 of the adapter and the body of the receptacle 1 and/or 3 may have a very good contact cyclically even when the adapter 2 is tilted. This structure may prevent RF leakages to a large extent, thus improving RF shielding.

When one end of the adapter is inserted inside a receptacle 1 or 3 having a second tapered surface as previously described, the other end of the adapter 2 may be inserted into another receptacle also having an internal second tapered surface, for example for BTB applications. When the distance of board to board reaches the design working range, the surface of the adapter may touch the second tapered surface of the receptacle tightly because of the force generated by the resilient element 23. The axial misalignment of the connector may thus vary from L1 to L2, see FIGS. 4 and 5, which may enable the electrical performances of the connector to remain constant and may also maintain the handling power of the connector.

The invention may provide the following advantages over connectors according to the prior art.

Because of the tapered surface of the receptacle, good contact with the surface of the adapter when the adapter is tilted in a certain angle may be obtained. The surface of central contact of the receptacle may have good concentricity with the surface of the body of the adapter, thereby also providing the good contact between the receptacle and the adapter. Radial misalignment of up to +/−2 mm may also be overcome.

The force generated by the element of resilient structure of the adapter may exert a force against the receptacle when in working range, which may enable the connector to benefit from low contact resistant and may also enable axial misalignment of up to or a least +/−1 mm to be overcome.

The non-slotted structure of the body of the adapter may also bring improvement as regards RF shielding of the connection among other things.

Significant axial and radial misalignment may be overcome with some or all of the above-mentioned exemplary embodiments of the invention, which may lead to reduced requirements as regards the position tolerance of the connectors while manufacturing PCBs, so the cost of manufacture the PCBs and of assembling PCBs and said connectors may be lowered.

The above-mentioned exemplary embodiments of the invention may also enable more pairs of coaxial connection to be made between two PCBs, without having to resort to cables, enabling the modular, systematic and small-scale development of the base station. Low RF leakage may prevent the base station with signal interference, providing a satisfactory guarantee as regards the integration of TX and RX modules.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A resilient-loaded connector, comprising:
receptacle comprising a body and a central contact inside the body and,
at least one adapter having a plug, the plug comprising a body and a central contact mounted in said body with an insulator being interposed therebetween,
the adapter and the receptacle being configured to be connected together at one end of the adapter,
an internal surface of the body of the receptacle including a tapered surface, the adapter having a resilient element, the body of the plug including a portion configured to be introduced into the body of the receptacle, said portion of the body of the plug having a non-slotted surface contacting said tapered surface of the internal surface of the receptacle when the adapter and the receptacle are joined.

2. The connector of claim 1, the central contact of the receptacle having a front surface and the central contact of the adapter having at least one slot configured to receive a front surface of the central contact of the receptacle when the adapter is connected to the receptacle.

3. The connector of claim 1, the internal surface of the body of the receptacle further comprising at least another tapered surface and at least one cylindrical surface, said cylindrical surface being located between the tapered surface and the other tapered surface.

4. The connector of claim 3, further comprising a second receptacle configured to be connected to the adapter at the other end of the adapter, the second receptacle comprising a body, a central contact and a clip configured to lock the adapter.

5. A resilient-loaded connector, comprising:
a receptacle comprising a body and a central contact inside the body, and
at least one adapter having a plug, the plug comprising a body and a central contact mounted in said body with an insulator being interposed therebetween, said adapter being configured to be connected to said receptacle,
an internal surface of the body of the receptacle including a tapered surface, the adapter having a resilient element, the central contact of the adapter having a front surface, the body of the plug comprising a portion configured to be introduced into the body of the receptacle, said portion of the body of the plug having a non-slotted surface contacting said tapered surface of the body of the receptacle,
the central contact of the receptacle comprising at least one slot configured to receive the front surface of the central contact of the adapter when the adapter and the receptacle are connected.

6. The connector of claim 2, the internal surface of the body of the receptacle further comprising at least another tapered surface and at least one cylindrical surface, said cylindrical surface being located between the tapered surface and the other tapered surface.
